(19) United States
(12) Patent Application Publication
(10) Pub. No.: US 2004/0186881 A1
(43) Pub. Date: Sep. 23, 2004

(54) Automated media library configuration

(75) Inventors: Jeff Porter, Springboro, OH (US); Glenn Tarcea, Ann Arbor, MI (US)

Correspondence Address: VAN PELT & YI LLP, 10050 N. FOOTHILL BLVD #200, CUPERTINO, CA, 95014, US

(73) Assignee: EMC Corp.

(21) Appl. No.: 10/737,714

(22) Filed: Dec. 16, 2003

Related U.S. Application Data
(60) Provisional application No. 60/434,471, filed on Dec. 18, 2002.

(51) Int. Cl. G06F 15/16

(52) U.S. Cl. 709/200; 707/1

(57) ABSTRACT

Automated media library configuration is disclosed. A first host associated with the library is queried to determine how the library is identified on the first host. The first host is queried to detect a device associated with the library. A second host having a connection to the device is identified. The second host is queried to determine how the device is identified on the second host.

### CROSS REFERENCE TO RELATED APPLICATIONS

This application claims priority to U.S. Provisional Patent Application No. 60/434,471 entitled Automated Media Management filed Dec. 18, 2002, which is incorporated herein by reference for all purposes.

Co-pending U.S. patent application Ser. No. ______ (Attorney Docket No. LEGAP010) entitled Automated Media Management, filed concurrently herewith, is incorporated herein by reference for all purposes; and co-pending U.S. patent application Ser. No. ______ (Attorney Docket No. LEGAP014) entitled Resource Allocation Aware Queuing of Requests for Media Resources, filed concurrently herewith, is incorporated herein by reference for all purposes.

### FIELD OF THE INVENTION

The present invention relates generally to media libraries and devices. More specifically, automated media library configuration is disclosed.

### BACKGROUND OF THE INVENTION

Fully or partially automated media libraries, sometimes referred to herein as “libraries” or “robots”, are available to store and manipulate storage media, such as tapes used to store computer data, e.g., for backup or archive purposes. A typical library may be equipped with a robotic or other mechanism for manipulating the media stored therein, such as by inserting a selected volume or unit of the media (e.g., a particular tape) into a device associated with the unit, e.g., a tape drive configured to write data to and/or read data from the media. In the computer network environment, e.g., a backup application may be used to store data from one or more computers or other devices connected to the network (sometimes referred to herein as network “nodes” or “hosts”) on storage media associated with a library.

For a large network, or in cases in which nodes on the network use a variety of different applications and/or hardware platforms, or where the nature of the data is diverse, or simply as a result of separate purchasing decisions being made over time by separate subsets of the group of users served by the network, it is possible to have two or more different backup applications in place. For similar reasons, a particular network may have associated with it more than one library, possible of different types, and a plurality of storage devices associated with each library. In addition, the hosts associated with the various storage devices may be connected to those devices in different ways, and the hosts themselves may be of different platform types (e.g., different operating systems).

Given this potential diversity, there is a need for an efficient and automated way to configure media libraries and their associated storage devices without regard to library type, device type, and host type.

### BRIEF DESCRIPTION OF THE DRAWINGS

Various embodiments of the invention are disclosed in the following detailed description and the accompanying drawings.

FIG. 1 is a block diagram illustrating one exemplary embodiment of a network environment and an automated media management system associated therewith.

FIG. 2 is a flowchart illustrating an automated process used in some embodiments to configure storage media libraries and associated devices for automated media management purposes.

FIG. 3 is a flow chart of a process used in some embodiments to define a media library, as in step 202 of FIG. 2.

FIG. 4 illustrates a user interface used in some embodiments to obtain basic information about a library to be configured.

FIG. 5 is a flow chart illustrating a process used in some embodiments to determine the path from a library server to a library being configured for media management purposes, as in step 306 of FIG. 3.

FIG. 6 is a flow chart of a process used in some embodiments to determine library characteristics, as in step 308 of FIG. 3.

FIG. 7 is a flow chart illustrating a process used in some embodiments to define the library resources (e.g., range of media) to be controlled by a media manager.

FIG. 8 is a flow chart illustrating a process used in some embodiments to detect and configure storage devices, as in step 204 of FIG. 2.

FIG. 9 is a flow chart illustrating a process used in one embodiment to detect devices to be configured, as in step 802 of FIG. 8.

FIG. 10 is a flow chart illustrating a process used in one embodiment to determine which host systems will be used with each storage device to be configured, as in step 804 of FIG. 8.

FIG. 11 is an illustration of a user interface used in some embodiments to obtain from a user an identification of the host(s) to be used with each device to be configured.

FIG. 12 is a flow chart illustrating a process used in some embodiments to associate each device to be configured with the host(s) having a connection to it, as in step 806 of FIG. 8.

FIG. 13 is a flow chart illustrating a process used in some embodiments to check a host to determine if it has a connection to a device, as in step 1206 of FIG. 12.

FIG. 14 is a flow chart illustrating a process used in one embodiment to determine the type of a host, as in step 1304 of FIG. 13.

### DETAILED DESCRIPTION

The invention can be implemented in numerous ways, including as a process, an apparatus, a system, a composition of matter, a computer readable medium such as a computer readable storage medium or a computer network wherein program instructions are sent over optical or electronic communication links. In this specification, these implementations, or any other form that the invention may take, may be referred to as techniques. In general, the order of the steps of disclosed processes may be altered within the scope of the invention.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and invention may be practiced according to the claims without some or all of these specific details. For the purpose of clarity, technical material that is known in the technical fields related to the invention has not been described in detail so that the invention is not unnecessarily obscured.

A media management application or device requires certain information about the libraries in which the media to be managed are stored, the associated hosts configured to control the libraries, the storage devices (e.g., tape drives) associated with the libraries, and the hosts that have connections to those storage devices. Automated configuration of a media library and associated devices and hosts for media management purposes is disclosed. A definition of a library is created based on basic information received from a user or other source combined with additional information learned via an automated discovery process about the library, its associated devices, and the hosts having connections to those devices.

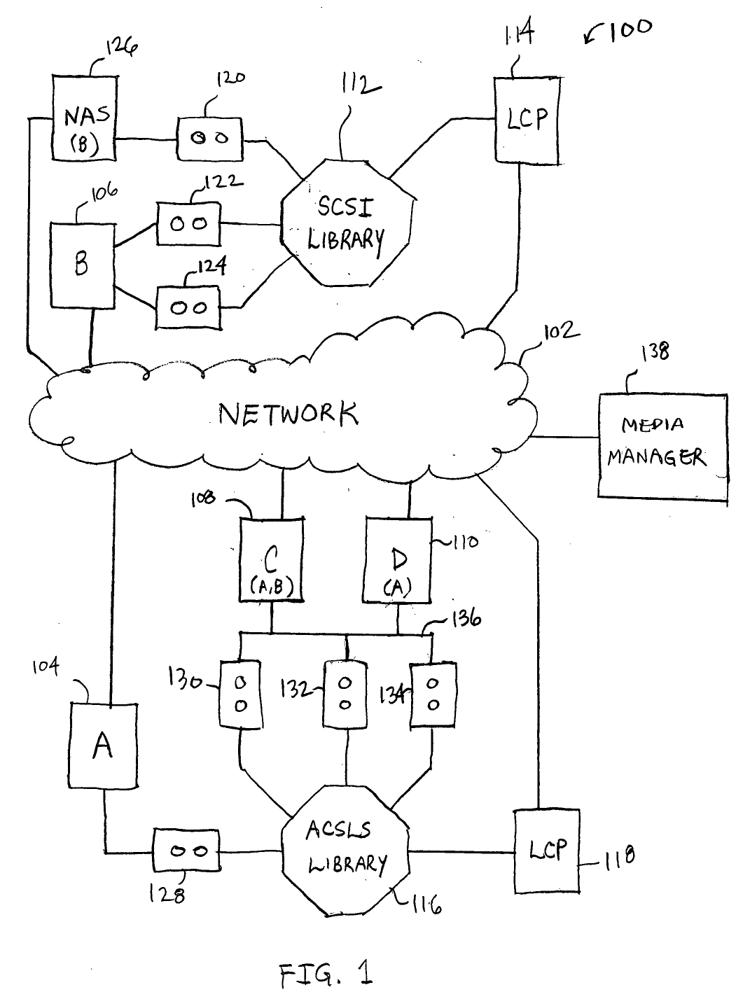

FIG. 1 is a block diagram illustrating one exemplary embodiment of a network environment and an automated media management system associated therewith. The system 100 comprises a network 102, which may be a local area network (LAN) or any type of private or public network. The system 100 further comprises servers A, B, C, and D, identified by reference numerals 104, 106, 108, and 110, respectively, in FIG. 1, connected to network 102. In the example shown in FIG. 1, a first backup application, such as the NetWorker backup application available commercially from the Legato Software Division of EMC Corporation, is installed on server A (104), and a second backup application is installed on server B (106). The first and second backup applications may be the same or different products. The data on server C (108) is backed up by both the first backup application installed on server A (104) and the second backup application installed on server B (106), as is indicated in FIG. 1 by the letters “A” and “B” in parentheses below the letter “C”. Such a configuration may be used, e.g., to provide two independent backups for particularly critical data. Server D (110) is backed up by the first backup application installed on server A (104). Server A may likewise comprise a body of data that is backed up by operation of the first backup application installed on server A, and server B may comprise a body of data that is backed up by operation of the second backup application installed on server B. The storage media used by the first and second backup applications installed on servers A and B, respectively, reside in two storage media libraries of different types. SCSI library 112 is a library configured to be controlled directly by a library host 114 via a small computer systems interface (SCSI) connection. Library host 114 is connected to SCSI library 112 and to network 102. ACSLS library 116 is an automated cartridge system library software-controlled library of the type available commercially from StorageTechnology Corporation (StorageTek) of Louisville, Colo. An ACSLS-type library such as library 116 is controlled using a software controller provided for that purpose, as opposed to being controlled directly by the library host. Library host 118 is connected to and configured to control ACSLS library 116. Library host 118 also is connected to network 102. While examples of a SCSI and ACSLS type library are shown in FIG. 1, any number of combination of types of libraries may be used, including without limitation IBM 3494, ADIC AML, and/or any other type of library. SCSI library 112 has associated with and connected to it tape drives 120, 122, and 124. Tape drive 120 is connected to a network attached storage (NAS) device 126. The data on NAS 126 is backed up by operation of the second backup application installed on server B. NAS 126 also has a connection to network 102. ACSLS library 116 has associated with and connected to it tape drives 128, 130, 132, and 134. Tape drive 128 is connected to server A. Tape drives 130, 132, and 134 are connected to servers C (108) and D (110) via a storage area network (SAN) 136. SAN 136 makes it possible for each of servers C and D to read from or write to any one of the SAN-connected drives 130, 132, and 134.

A media management application is installed on a media manager 138 to coordinate operations between the first backup application running on server A and the second backup application running on server B, such as by receiving and arbitrating between potentially competing requests for resources associated with libraries 112 and 116, as well as executed such requests. For example, the media manager may receive requests from the backup applications that a particular tape residing in one of the libraries be inserted into a tape drive associated with that library. The media management application may provide other functionality, such as keeping track of tapes stored in the libraries and elsewhere. The media manager 138 has a connection to the network 102, which it uses to communicate with other nodes connected to network 102 as described more fully below. The media manager 138 may comprise a server connected to network 102.

Each of servers A, B, C, and D may comprise different hardware and/or may be running a different operating system (or version thereof). In addition, the type of media stored in SCSI library 112 and ACSLS library 116 may vary. Also, certain elements may be connected to an associated tape device differently than others. For example, servers C and D are connected to tape drives 130, 132, and 134 via a SAN, while servers A and B may have direct SCSI connections to the tape drives to which they are connected. In one embodiment the NAS 126 is connected to tape drive 120 via the network data management protocol (NDMP). Under the NDMP protocol, an NDMP server installed on NAS 126 is configured to control the interaction of NAS 126 with tape drive 120. Applications requiring interaction with NAS 126 with respect to tape drive 120, such as the second backup application installed on server B, must comprise an NDMP client configured to send requests in the proper format to the NDMP server running on NAS 126.

To perform its functions, media manager 138 requires certain information about the media, libraries, devices, and hosts associated with the media it is to manage. For example, the media manager 138 needs to know with respect to each library the library type, the library server host, how the library server host is configured (e.g., whether it is NDMP configured), which storage devices are associated with the library (i.e., to which devices is the library configured to mount/unmount tapes), and how are those devices identified by the library. Certain information about the physical setup and other characteristics of the library also is required. The media manager 138 also needs to know with respect to each storage device the host(s) having a connection to the device and the device file or other name or path by which the device is known on each host. While it would be possible to require that a system administrator manually gather all of the required information and provide it to the media manager via a user interface, such an approach would require that the administrator have a particular level of knowledge and skill and it would in addition be labor intensive, time consuming, and prone to human error in the collection, collation, and entry of data. Therefore, it would be advantageous to automate all or part of the process of configuring a library and its associated devices for automated media management purposes.

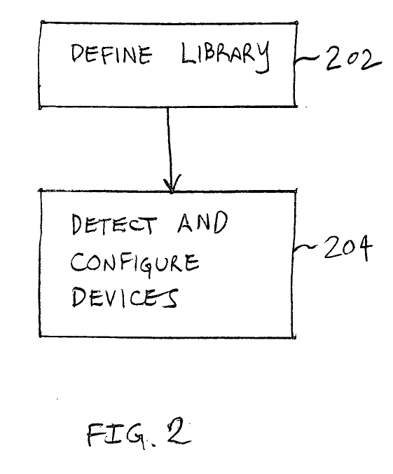

FIG. 2 is a flowchart illustrating an automated process used in some embodiments to configure storage media libraries and associated devices for automated media management purposes. In step 202, a storage media library is defined. In step 204, devices associated with the library defined in step 202 are detected and configured. In some embodiments, steps 202 and 204 are repeated for each library to be configured. For example, in the case of the network environment shown in FIG. 1, the process shown in FIG. 2 would be repeated for each of SCSI library 112 and ACSLS library 116.

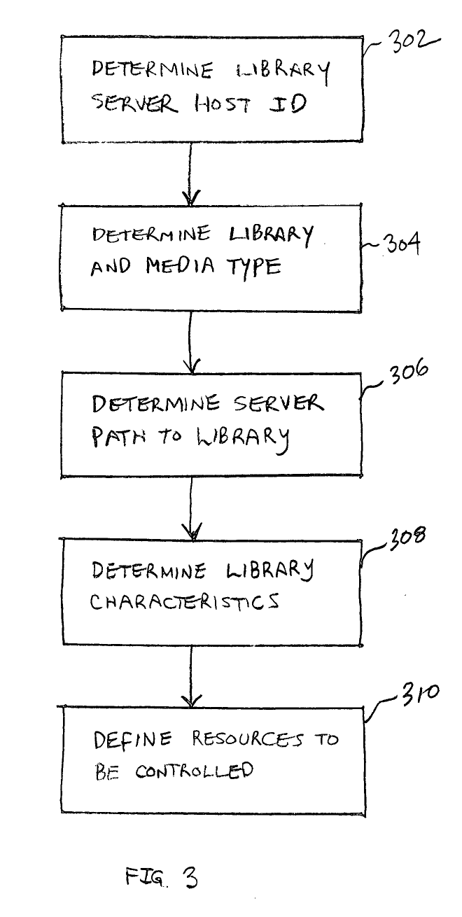

FIG. 3 is a flow chart of a process used in some embodiments to define a media library, as in step 202 of FIG. 2. In step 302, the name or other identifier by which the library server host is known on the network served by the media manager (e.g., the host name on network 102 of the environment shown in FIG. 1) is determined. In step 304, the library and media type are determined. In step 306, the path to the library on the library server is determined. In some embodiments, step 306 may comprise identifying a device file associated with the library. In some embodiments, step 306 may comprise determining a hardware address associated with the library. In step 308, characteristics of the library are determined. In step 310, the library resources to be controlled (e.g., the range of tapes) are defined.

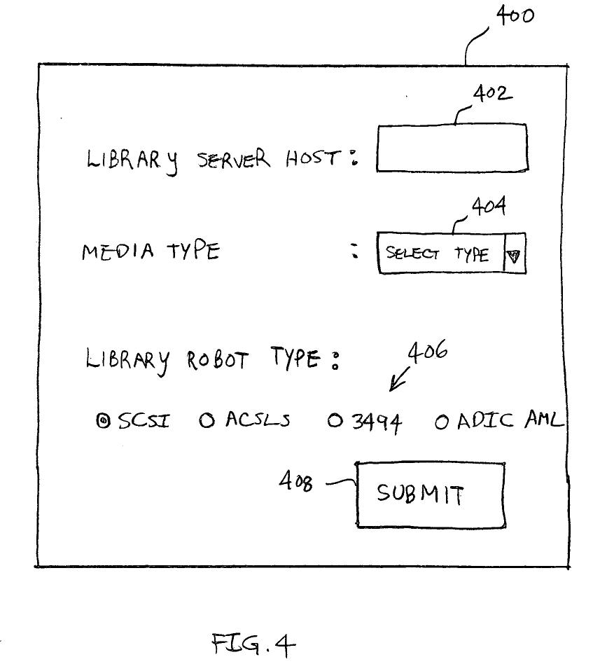

FIG. 4 illustrates a user interface used in some embodiments to obtain basic information about a library to be configured. In some embodiments, the user interface shown in FIG. 4 may be used to obtain from a user, such as a system administrator, the information determined in steps 302 and 304 of the process shown in FIG. 3. The user interface comprises a display 400 that includes a library server host name/identifier input box 402. The display 400 further includes a media type pull down menu 404 that enables a user to select the type of media stored in the library being configured from among a list of options. In some embodiments, the list of options may include an “mixed” or “multiple type” option which, if selected, causes additional screens to be displayed to enable a user to define more precisely the different types of media included in the library. The display 400 further includes a set of library robot type radio buttons 406 that enables a user to indicate the type of library being configured by selecting the corresponding radio button. While an input box, pull down menu, and robot buttons are shown for items 402, 404, and 406, respectively, any type of input that is suitable to the applicable data and/or options may be used. The display 400 includes a “submit” button 408 which, when selected, causes the data and options entered by the user in items 402, 404, and 406 to be submitted to the media manager for processing.

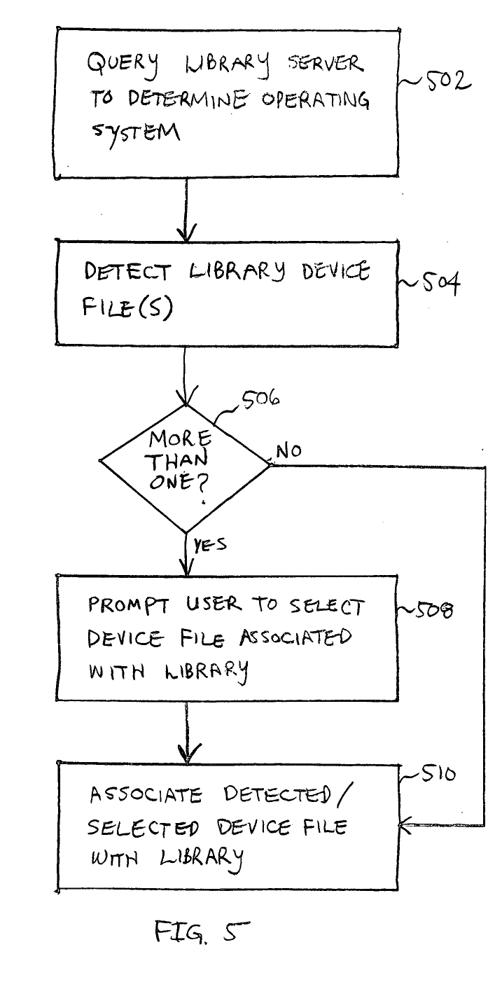

FIG. 5 is a flow chart illustrating a process used in some embodiments to determine the path from a library server to a library being configured for media management purposes, as in step 306 of FIG. 3. The process begins in step 502, in which a query is sent to the library server to determine what operating system is being run on the server. In some embodiments, step 502 comprises sending a query to a software agent installed on the library server. In some such embodiments, the agent may comprise a library control program (LCP). The LCP may be configured and provided as described in the concurrently filed co-pending application entitled “Automated Media Management”, which is incorporated herein by reference above. In step 504, any library device files on the library server are detected. In some embodiments, step 504 is performed on the library server by an agent such as described above. Step 504 may comprise searching for files that conform to a syntax or naming convention known to be used by the operating system identified in step 502 for naming libraries. In step 506, it is determined whether more than one device file potentially associated with the library being configured was found. If it is determined in step 506 that only one library device file was found, the process advances to step 510 in which the detected device file is associated with the library being configured. In some embodiments, a user may be asked to confirm prior to step 510 being performed that the correct device file has been found. If it is determined in step 506 that more than one library device file was found, the process proceeds to step 508, in which a user is prompted to select the correct device file for the library being configured from among the device files found. The process then continues to step 510 in which the device file selected by the user is associated with the library being configured. In this way, the library device file is discovered in an automated process that does not require a user to obtain and enter the device file manually prior to configuring the media manager to manage the library.

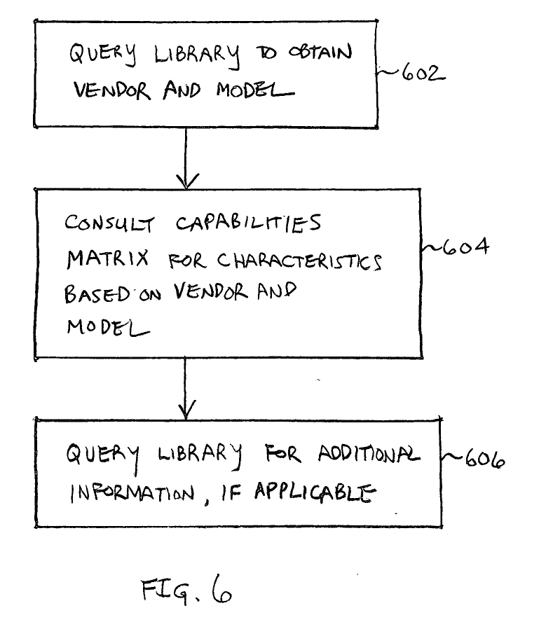

FIG. 6 is a flow chart of a process used in some embodiments to determine library characteristics, as in step 308 of FIG. 3. In step 602, the library server is queried to determine the vendor make and model of the library. In some embodiments, step 602 may comprise sending a query to an agent installed at the library server, as described above. In some embodiments, step 602 may comprise sending a query to an agent installed at the library server to cause the library server to query the library itself to obtain the information. In step 604, a capabilities matrix is consulted to obtain additional characteristics of the library based on the vendor make and model. The capabilities matrix comprises an information base of data concerning potentially relevant characteristics of various makes and models of library. In step 606, the library server and/or library may be queried to obtain additional information about the library, if applicable. For example, the capabilities matrix may indicate that the make and model identified in step 602 may be configured more than one way, and in such a case step 606 may comprise querying the library server and/or library to determine the particular configuration of the library being configured. The capabilities matrix may also indicate that for the particular make and model being configured other additional and potentially relevant information may be available from the library server or library, and step 606 may comprise sending additional queries to obtain such information. By the process shown in FIG. 6, then, additional information is discovered about the library automatically, without requiring further user input.

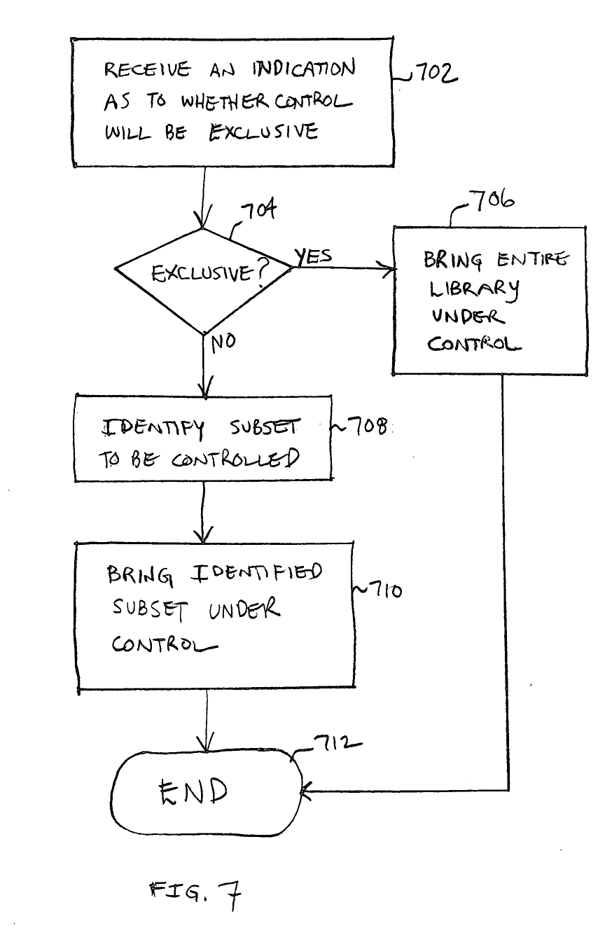

FIG. 7 is a flow chart illustrating a process used in some embodiments to define the library resources (e.g., range of media) to be controlled by a media manager. In step 702, an indication is received as to whether control of media resources associated with the library (e.g., tapes stored therein) will be exclusive. If in step 704 it is determined that the indication received in step 702 is that control is to be exclusive, the process advances to step 706, in which the entire library is brought under the control of the media manager, after which the process ends in step 712. If in step 704 it is determined that the indication received in step 702 is that control is not to be exclusive, the process proceeds to step 708, in which the subset of media resources in the library that is to be controlled by the media manager is identified. In some embodiments, step 708 comprises prompting a user to identify the subset of media to be controlled, such as by entering a range of bar codes or other identifiers. In step 710, the subset of media identified in step 708 are brought under the control of the media manager, after which the process ends in step 712.

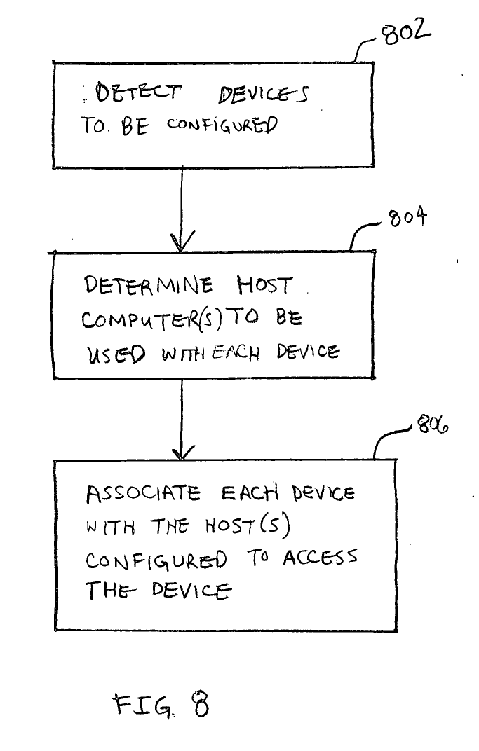

FIG. 8 is a flow chart illustrating a process used in some embodiments to detect and configure storage devices, as in step 204 of FIG. 2. The process begins in step 802 in which the devices to be configured are detected. In some embodiments, step 802 comprises sending a query to an agent on the library server to obtain from the library a list of devices associated with the library (e.g., a list of devices on which the library is configured to mount tapes). In step 804, the host computer(s) having a connection with each device are identified. In some embodiments, step 804 may comprise identifying only the host computer(s) having a connection to be managed by the media manager, and may not include identifying all hosts having a connection to a device. In some embodiments, step 804 may comprise receiving from a user an identification of host system candidates and receiving from a user an indication of which host system candidates have a connection to each device. In step 806, each device to be configured is associated with the host(s) having a connection to the device. In some embodiments, step 806 comprises defining a connection that associates a host with both (1) the device as it is known on that host and (2) the device as it is known to the library configured to mount media volumes (e.g., tapes) on the device.

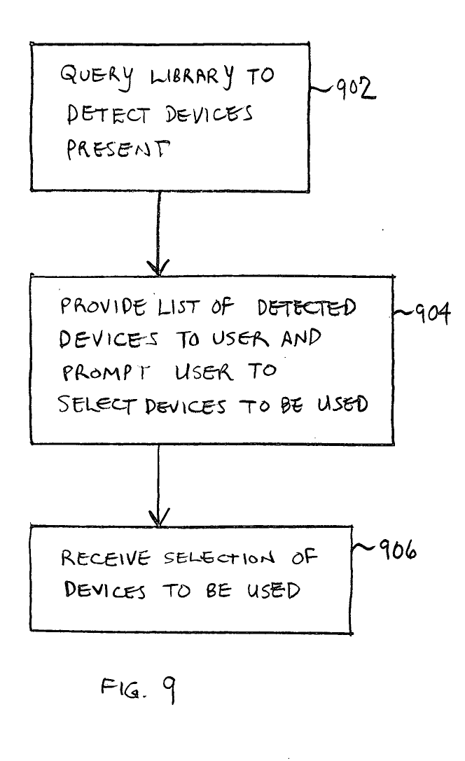

FIG. 9 is a flow chart illustrating a process used in one embodiment to detect devices to be configured, as in step 802 of FIG. 8. In step 902, the library being configured is queried to detect the devices present. In some embodiments, step 902 may comprise sending a query to an agent on the library server configured to control the library. In step 904, a list of detected devices is provided to a user via a user interface, and the user is prompted to select the devices to be configured. In step 906, a selection of the devices to be used is received.

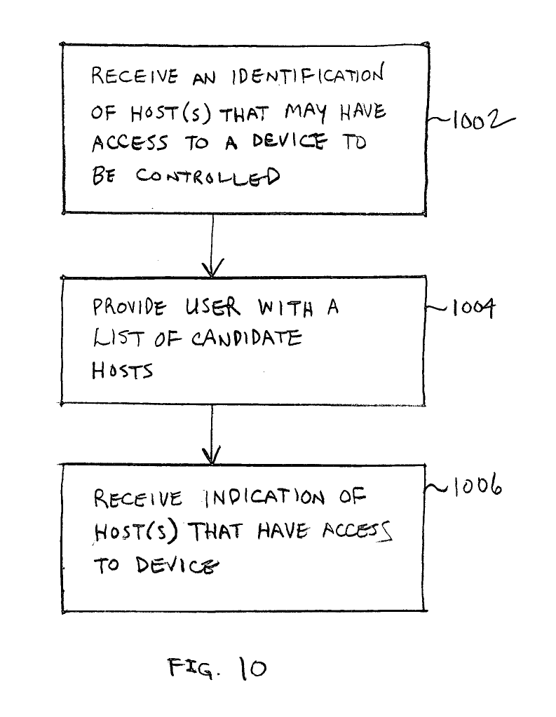

FIG. 10 is a flow chart illustrating a process used in one embodiment to determine which host systems will be used with each storage device to be configured, as in step 804 of FIG. 8. In step 1002, an identification of host(s) that may have access to a device to be configured is received. In some embodiments, step 1002 may comprise receiving from a user via a user interface an identification of one or more hosts systems. In some embodiments, the user is prompted to provide an identification of all hosts having a connection to a device to be configured. In step 1004, a user is provided with a list of candidate hosts (e.g., the hosts identified in step 1002) and prompted to provide with respect to each device to be configured an indication as to which host(s) have a connection to the device. In step 1006, an indication of the host(s) having a connection to the device is received for each device to be configured.

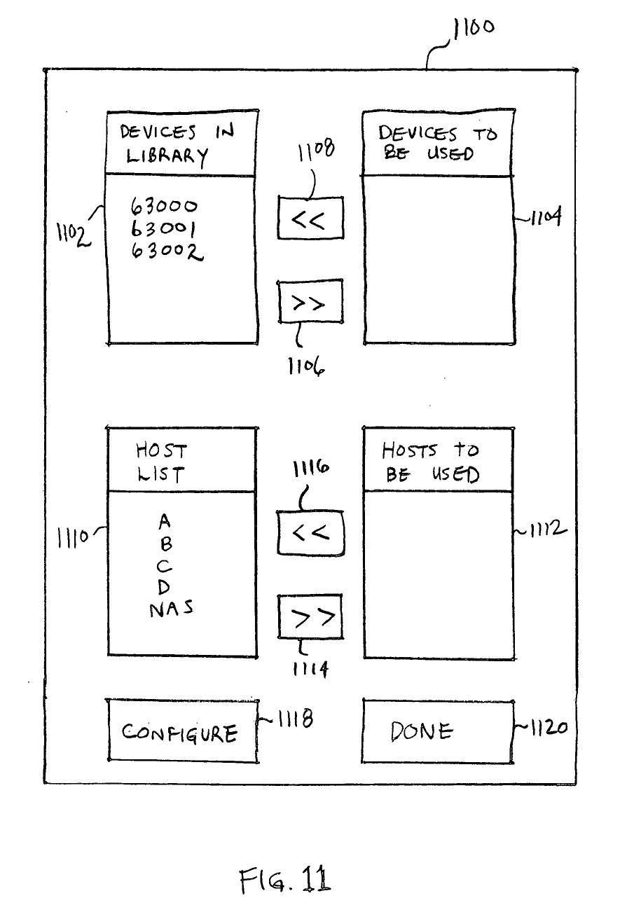

FIG. 11 is an illustration of a user interface used in some embodiments to obtain from a user an identification of the host(s) to be used with each device to be configured. The display 1100 comprises a “devices in library” display area 1102 in which the devices detected as being associated with the library being configured are listed. In some embodiments, the devices are identified by the device number by which they are known to the library. The display 1100 further includes a “devices to be used” display area 1104 in which one or more devices may be listed as those that are to be associated with the corresponding host(s) identified as described below. A user may add a device from display area 1102 to display area 1104 by highlighting the device as displayed in area 1102 and selecting the “add device” button 1106. Similarly, a device may be moved from display area 1104 back to display area 1102 by highlighting the device as displayed in display area 1104 and selecting the “remove device” button 1108. The display 1100 further comprises a “host list” display area 1110 in which a lists of hosts identified previously by a user to the media manager is displayed. The display 1100 also includes a “hosts to be used” display area 1112, in which hosts to be associated with the device(s) listed in display area 1104 are displayed. A user may add a host from “host list” display area 1110 to “hosts to be used” display area 1112 by highlighting the host as displayed in display area 1110 and selected the “add host” button 1114. Similarly, a host may be moved from display area 1112 back to display area 1110 by highlighting the device as displayed in display area 1112 and selecting the “remove host” button 1116. Selection of “configure” button 1118 causes the media manager to automatically associating the devices listed in display area 1104 with the hosts listed in display area 1112. The media manager defines for each device-host pair a connection that associates the device with the name (or device file or other identifier) by which it is known on the host and with the name by which it is known to the library. Each device or group of devices may be configured as described above through successive iterations of listing the device(s) in display area 1104, listing the associated host(s) in display area 1112, and selecting “configure” button 1118. The user may indicate that all devices to be configured have been configured by selecting “done” button 1120.

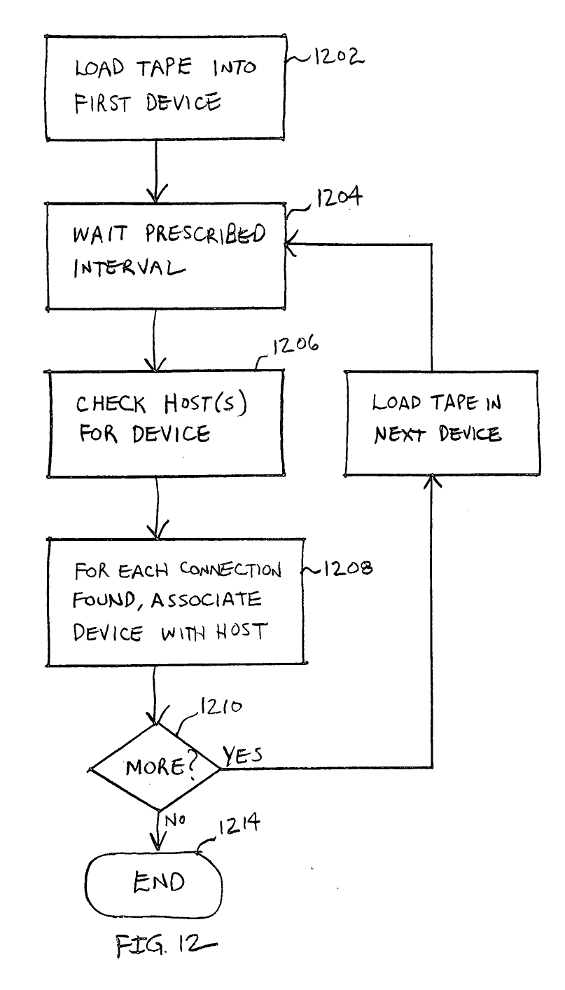

FIG. 12 is a flow chart illustrating a process used in some embodiments to associate each device to be configured with the host(s) having a connection to it, as in step 806 of FIG. 8. In step 1202, a tape is loaded into a first device to be configured. In step 1204, a prescribed wait interval is allowed to expire. The wait interval is selected to allow time for the tape to be loaded and the device to come on line. In step 1206, the host(s) indicated as having a connection to the device are checked to determine if a connection to the device is in fact present and to identify the device file for the device on each host. In step 1208, for each connection found the device is associated with the host and the device file (or other identifier) by which the device is known on the host. In step 1210, it is determined whether any more devices are to be configured. If there are more devices to be configured, the process advances to step 1212, in which a tape is loaded into the next device to be configured, and steps 1204 through 1208 are repeated for that device. If there are no more devices to be configured, the process ends in step 1214.

In some alternative embodiments, device serial number information may be used to associate each device to be configured with the host(s) having a connection to it. In such embodiments, the device is first queried to determine its serial number. Each host candidate is then queried to determine if it has a connection to a device having that serial number. For each host that does have such a connection, a mapping is made between the device serial number and the device file (or other identifier) by which the device is known on the host. Such alternative embodiments, it is not necessary to actually load a tape into the device to determine which hosts have a connection to the device.

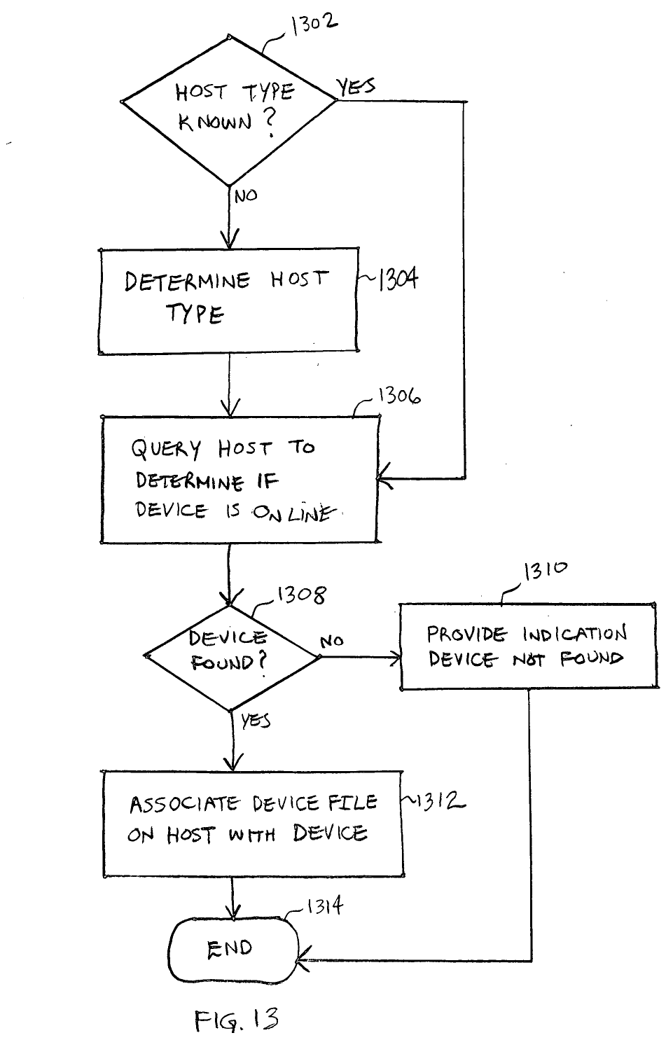

FIG. 13 is a flow chart illustrating a process used in some embodiments to check a host to determine if it has a connection to a device, as in step 1206 of FIG. 12. In step 1302, it is determined whether the host type is known. The host type indicates to the media manager how the media manager must communicate with the host. For example, if the host has a software agent, e.g., a drive control program (DCP), installed, the media manager can communicate with the host via the installed agent. If the host is NDMP-configured, the media manager will have to communicate with the host through a communication surrogate configured to operate as an NDMP client. If the host type is not known, the process proceeds to step 1304 in which the host type is determined. If the host type is known, or once the host type has been determined in step 1304, the process advances to step 1306 in which the host is queried to determine if the device being configured is on line. In step 1308, it is determined whether the device was found to be on line in step 1306. If the device was not found, the process proceeds to step 1310, in which an indication that the device was not found is provided, after which the process ends in step 1314. If the device was found, the process advances to step 1312 in which the device is associated with the host and the device file (or other identifier) by which it is identified on the host. The process then ends in step 1314.

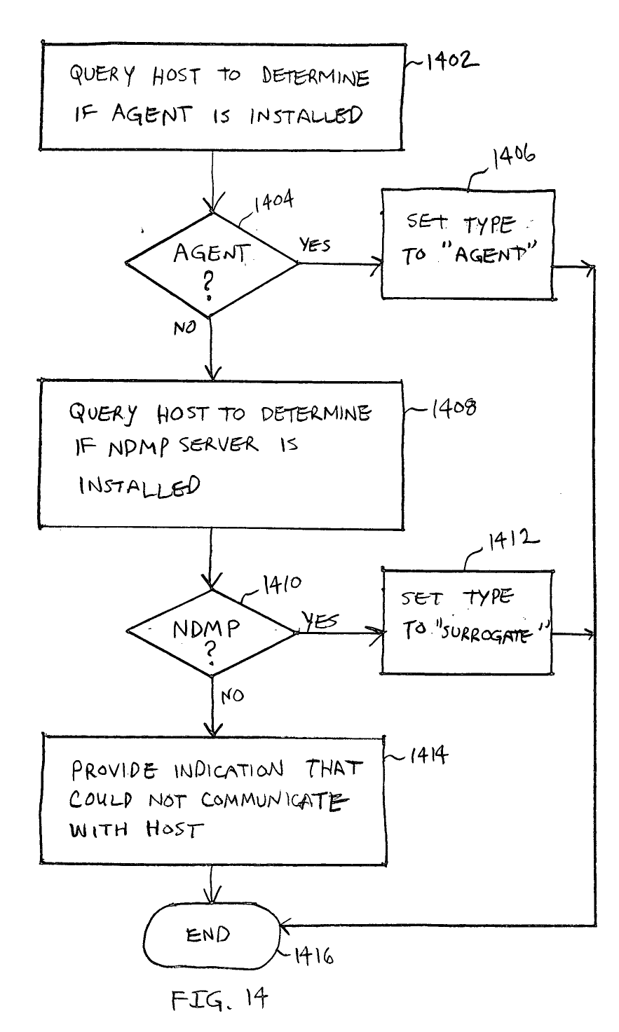

FIG. 14 is a flow chart illustrating a process used in one embodiment to determine the type of a host, as in step 1304 of FIG. 13. In step 1402, the host is queried to determine if a software agent (e.g., DCP) is installed thereon. Step 1402 may comprise sending a DCP “hello” request to the host. In step 1404, it is determined whether a response to the query sent in step 1402 was received indicating that an agent is installed on the host. If an agent is installed, the process proceeds to step 1406, in which the host type is set to “agent”, after which the process ends in step 1416. If an agent is not installed, the process advances to step 1408, in which a query is sent to determine if the host is NDMP-configured. In some embodiments, step 1408 comprises sending an NDMP “hello” request via a communications surrogate, such as a DCP/surrogate installed on media manager 138 of FIG. 1. In step 1410, it is determined whether a response to the NDMP “hello” request was received. If a response was received, the process proceeds to step 1412 in which the host type is set to “surrogate”, after which the process ends in step 1416. If no response is received, the process advances to step 1414, in which an indication is provided that communication could not be established with the host, after which the process ends in step 1416. In some embodiments, additional steps not shown in FIG. 14 may be required to facilitate the completion of steps 1408 and 1410, such as by prompting a user to supply an NDMP username and password.

Referring further to FIG. 1, the techniques described herein may be used to configure a media manager and the libraries and devices it is to manage in a heterogeneous environment such as the one shown in FIG. 1 using a process automated as described herein. For example, to configure the SCSI library 112 and associated devices 120, 122, and 124, all that a user would be required to do is provide an identification of library server 114, an indication of the library and media type, and an identification of hosts NAS 126 and server B (106). The media manager 138 would then, as described herein, discover additional information about library 112, including the list of devices associated with the library (i.e., devices 120, 122, and 124). A user would optionally be prompted to identify which of the hosts (106, 126) have a connection with which devices (this information could, in an alternative embodiment, simply be discovered by checking all hosts for a connection), after which the media manager would automatically determine whether such a connection is in fact present and, if so, what device file or other identifier is used on each host to identify each device to which the host has a connection. The media manager would then create for each host-device pair (e.g., NAS 126-device 120, server B-device 122, and server B-device 124) a connection associating the device with the host, the identifier by which the device is known on the host, and the identifier by which the device is known to the library. With this information, media management tasks, such as causing a particular volume to be mounted on, ejected from, unmounted from a particular drive, etc., may be performed by the media manager. The ACSLS library 116 would be configured through a similar automated process by which the following connections would be defined: server A-device 128, server C-device 130, server C-device 132, server C-device 134, server D-device 130, server D-device 132, and server D-device 134. In some embodiments, a user may choose not to define one or more of the physically present connections, as in the case where a user desires that a particular device be dedicated for use by a particular host.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A method for configuring a library for automated media management, comprising:
querying a first host associated with the library to determine how the library is identified on the first host;
querying the first host to detect a device associated with the library;
identifying a second host having a connection to the device; and
querying the second host to determine how the device is identified on the second host.

2. The method of claim 1, wherein querying the first host to determine how the library is identified on the first host comprises identifying a device file by which the library is known on the first host.

3. The method of claim 1, wherein querying the first host to determine how the library is identified on the first host comprises determining a hardware address associated with the library.

4. The method of claim 1, wherein querying the first host to detect a device associated with the library comprises determining an identifier by which the device is known to the library.

5. The method of claim 1, wherein querying the second host comprises determining an identifier by which the device is known to the second host.

6. The method of claim 1, wherein querying the second host comprises determining a device file associated with the device on the second host.

7. The method of claim 1, wherein querying the first host to detect a device associated with the library comprises determining a first identifier by which the device is known to the library, querying the second host comprises determining a second identifier by which the device is known to the second host, and further comprising associating the device with the library, the first identifier, the second host, and the second identifier.

8. The method of claim 1, further comprising receiving an identification of the first host.

9. The method of claim 1, further comprising determining a characteristic of the library.

10. The method of claim 1, further comprising determining a characteristic of the library by consulting a capabilities matrix.

11. The method of claim 1, further comprising:
querying the first host to obtain make and model information for the library; and
determining a characteristic of the library based on said make and model information.

12. The method of claim 1, wherein querying the second host comprises:
causing a volume of media to be mounted on the device;
querying the second host to determine if the device is on line; and
if the device is determined to be on line at the second host, recording an identifier by which the on line device is known to the second host.

13. The method of claim 1, wherein querying the first host to detect a device associated with the library comprises sending a request to an agent installed on the first host.

14. The method of claim 1, further comprising determining whether an agent is installed on the first host.

15. The method of claim 1, wherein querying the first host to detect a device associated with the library comprises sending a request via a communication surrogate to a network data management protocol (NDMP) server running on the first host.

16. The method of claim 1, further comprising determining whether a network data management protocol (NDMP) server is running on the first host.

17. The method of claim 1, wherein querying the second host comprises sending a request to an agent installed on the second host.

18. The method of claim 1, wherein querying the second host comprises sending a request via a communications surrogate to a network data management protocol (NDMP) server running on the second host.

19. The method of claim 1, further comprising:
detecting a second device associated with the library;
identifying a third host having a connection to the second device; and
querying the third host to determine how the second device is identified on the third host.

20. The method of claim 1, wherein identifying a second host comprises:
providing a user interface prompting a user to identify hosts having a connection to the device; and
receiving via said user interface a user input comprising an identification of the second host.

21. The method of claim 1, wherein querying the second host to determine how the device is identified on the second host comprises searching the second host for a device file.

22. The method of claim 1, wherein querying the second host to determine how the device is identified on the second host comprises scanning the second host for a file having a format associated with the operating system running on the second host.

23. A system for configuring a library for automated media management, comprising:
a processor configured to:
query a first host associated with the library to determine how the library is identified on the first host;
query the first host to detect a device associated with the library;
identify a second host having a connection to the device; and
query the second host to determine how the device is identified on the second host; and
a communications interface configured to enable the processor to send queries to said first and second hosts.

24. A computer program product for configuring a library for automated media management, the computer program product being embodied in a computer readable medium and comprising computer instructions for:
querying a first host associated with the library to determine how the library is identified on the first host;
querying the first host to detect a device associated with the library;
identifying a second host having a connection to the device; and
querying the second host to determine how the device is identified on the second host.
